(19) United States
(12) Patent Application Publication
(10) Pub. No.: US 2010/0060241 A1
(43) Pub. Date: Mar. 11, 2010

(54) METHOD AND DEVICE FOR DETERMINING AN EQUALIZING CHARGE OF AN ACCUMULATOR

(75) Inventor: Hans-Walter Folge, Peine (DE)

Correspondence Address: FOLEY & LARDNER LLP, 777 EAST WISCONSIN AVENUE, MILWAUKEE, WI, 53202-5306, US

(73) Assignee: Johnson Controls Hybrid and Recycling GmbH

(21) Appl. No.: 12/553,807

(22) Filed: Sep. 3, 2009

Related U.S. Application Data
(63) Continuation of application No. PCT/EP2008/001710, filed on Mar. 4, 2008.

(30) Foreign Application Priority Data
Mar. 5, 2007 (DE) DE102007010988.3

(51) Int. Cl. H02J 7/04

(52) U.S. Cl. 320/152; 320/162; 320/150

(57) ABSTRACT

A method for determining an equalizing charge of a battery in which the battery is overcharged beyond a nominal full state of charge includes detecting full charging operating phases in which the battery is at least in the nominal full state of charge and adding up charge quantities which are charged into the battery in the full charging operating phases to obtain a value of the equalizing charge.

### CROSS-REFERENCE TO RELATED PATENT APPLICATIONS

This application is a Continuation of International Patent Application No. PCT/EP2008/001710, filed Mar. 4, 2008, which claims the benefit of and priority to German Priority Application DE 10 2007 010 988.3, filed Mar. 5, 2007. The entire disclosures of International Patent Application No. PCT/EP2008/001710 and German Priority Application DE 10 2007 010 988.3 are incorporated by reference herein.

### BACKGROUND

The invention relates to a method and a device for determining an equalizing charge of an accumulator (i.e., an electrochemical cell or battery), in which the accumulator is overcharged beyond a nominal full state of charge.

In order to equalize the charge of accumulators, in particular of nickel-metal hydride accumulators (NiMH), the accumulator is overcharged with a specific charge amount. For this purpose, the accumulator has, to date, been continuously charged with a constant and relatively small current in order to be able to detect an equalizing charge. The charging process can last for several hours, until a battery monitoring system has detected a fully charged and possibly also equalized accumulator. If the charging process is constantly interrupted, equalizing charging with the existing control and monitoring method may never be successful. The accumulator is generally always charged using a mains charger in order to be able to guarantee a continuous charging current.

However, for modern hybrid vehicles, no provision is made to charge the accumulator via a mains supply. In order to generate the required constant and low charge current, relatively long operating phases with the internal combustion engine are required, for example relatively long journeys on the motorway. Overnight charging of the hybrid battery using a 12V starter battery would also be feasible. However, the disadvantage is that the vehicle control means cannot know in advance how long a motorway journey will last. Equalizing charging by means of a 12 V starter battery could also be interrupted during the night.

Taking the above as a starting point, it would be advantageous to provide an improved method together with a corresponding device for determining an equalizing charge of an accumulator, with which method the equalizing charge can be controlled under diverse operating conditions.

### SUMMARY

An exemplary embodiment relates to a method for determining an equalizing charge of a battery in which the battery is overcharged beyond a nominal full state of charge includes detecting full charging operating phases in which the battery is at least in the nominal full state of charge and adding up charge quantities which are charged into the battery in the full charging operating phases to obtain a value of the equalizing charge

Another exemplary embodiment relates to a monitoring device for batteries that includes a device for identifying a current state of charge of a battery and a charge measuring unit for continuously measuring charge quantities that are charged into the battery. The monitoring device also includes a monitoring unit configured to detect full charging operating phases in which the battery is at least in a nominal full state of charge and to add up the charge quantities that are charged into the battery in full charging operating phases, the monitoring unit further configured to determine an equalizing charge of the battery as a function of the added-up charge quantities.

### BRIEF DESCRIPTION OF THE DRAWINGS

The invention will be explained by way of example in greater detail below with reference to the appended drawings, in which:

FIG. 1 shows a block diagram of a monitoring device for accumulators, with an accumulator which is incorporated in a vehicle system being connected to said monitoring device, and

FIG. 2 shows a flow chart for determining an equalizing charge of an accumulator.

### DETAILED DESCRIPTION

According to an exemplary embodiment, a method of determining an equalizing charge of an accumulator includes detecting charging operating phases in which the accumulator is at least in the nominal full state of charge, and adding up the charge quantities, which are charged into the accumulator in the full charging operating phases, in order to obtain the value of the equalizing charge.

The method is based on the knowledge that the essential feature of equalizing charging is that the accumulator is overcharged with a specific charge quantity of approximately 10 to 20% of the nominal capacity and it is not absolutely necessary for current to flow continuously. It has been found that intervals may be present between the charging processes. The method according to the invention therefore utilizes the knowledge that an accumulator can be overcharged with a defined charge quantity relatively independently of how long the charging process lasts and how the charging process is carried out.

To this end, the charge quantities which are charged into the accumulator in the full charging operating phases are simply added up. As a result, only the charge quantities which are charged into the accumulator in an overcharging phase, in which the state of charge of the accumulator has reached the maximum value, are taken into consideration. If the overcharging phase is interrupted by discharging phases, adding-up of the charge quantities is likewise interrupted until a new, further overcharging phase begins.

The charge quantities which are added-up in the precharging operating phases are preferably compared with a defined setpoint equalizing charge. Successfully concluded equalizing charging is identified when the quantity of the added-up charge quantities is greater than a setpoint equalizing charge. As soon as a predefined, adequate charge quantity has been charged into the accumulator, the end of an equalizing charging operation is identified, it being possible to terminate said charging operation by intervening in the power control means of the accumulator.

It is also advantageous when the voltage differences between a highest and a lowest module voltage are determined (preferably continuously) and the voltage differences are compared with a defined maximum voltage difference. As soon as the voltage difference is less than the defined maximum voltage difference, successfully concluded equalizing charging can be inferred.

Identification of successfully concluded equalizing charging preferably requires the added-up charge quantities to be greater than the setpoint equalizing charge, and the voltage difference to be less than the defined maximum voltage difference.

Successfully concluded equalizing charging can be inferred only when the two criteria are fulfilled.

It is further advantageous when the battery temperature is measured preferably continuously and an equalizing charging process by overcharging the accumulator is interrupted when the measured battery temperature is greater than a defined maximum temperature. This prevents the accumulator becoming too hot for equalizing charging and being able to cool down again, in order to be able to continue the equalizing charging with an accumulator which is at a suitable temperature.

The maximum accumulator temperature should be in the range of from 40 to 50° C. and, for example, be fixed at 45° C. for NiMH accumulators.

It is also advantageous to determine the state of charge, preferably continuously, and to interrupt equalizing charging when the state of charge is less than the defined minimum state of charge.

This ensures that the attempt to overcharge an accumulator is carried out only when a defined minimum state of charge is reached. The minimum state of charge should be in the range of from 80 to 100%, and should preferably be 90%. Only after this minimum state of charge is reached can an attempt be made to switch the accumulator to the overcharging phase in which the state of charge has reached the maximum value for the accumulator.

According to an exemplary embodiment, a monitoring device for accumulators includes a state of charge identification means for identifying the current state of charge of the accumulator, and a charge measuring unit for continuously determining the charge quantities charged into the accumulator, said monitoring device being designed to carry out the above-described method and having a monitoring unit which is designed to detect a full charging operating phase in which the accumulator is at least in the nominal full state of charge, and for adding-up the charge quantities which are charged into the accumulator in the full charging operating phases, and for determining an equalizing charge of an accumulator in order to obtain the value of the equalizing charge from the added-up charge quantities.

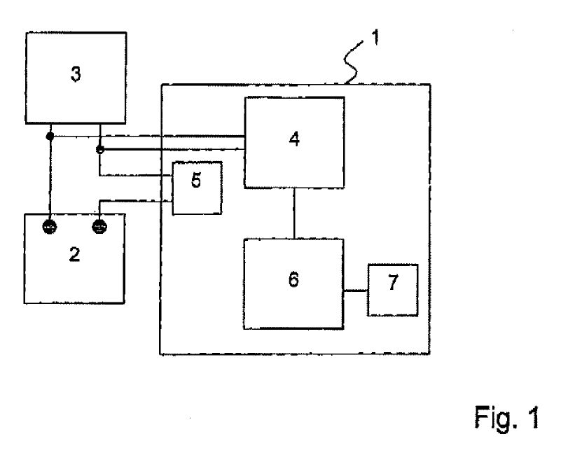

FIG. 1 shows a block diagram of a monitoring device 1 for accumulators 2 which are incorporated, for example, in an on-board electrical system 3 of a vehicle. The monitoring device 1 has a state of charge identification means 4 in order to determine the current state of charge SOC of the accumulator 2. The state of charge identification means is sufficiently well known and therefore will not be explained in any detail. The state of charge of an accumulator 2 is, for example, the capacity currently available in an accumulator 2 in relation to the nominal capacity of the accumulator 2, and is indicated as a percentage of the nominal capacity.

Furthermore, the monitoring device 1 has a charge measuring unit 5 in order to determine the charge quantities charged into the accumulator 2 and possibly also the charge quantities discharged from the accumulator 2. This can be performed, for example, by a current sensor.

The monitoring device 1 also has a monitoring unit 6 in order to detect full charging operating phases using the state of charge determined by the state of charge identification means 4, in which operating phases the accumulator is in an overcharging phase. As soon as a full charging operating phase of this type has been detected, the charge quantities determined with the charge measuring unit 5 are added-up in the monitoring unit in order to obtain the value of the equalizing charge. The value of the accumulated charge quantities is stored in a memory 7 of the monitoring device 1. In addition, component voltages across modules of the accumulator 2 are measured in order to be able to determine the highest and lowest module voltage.

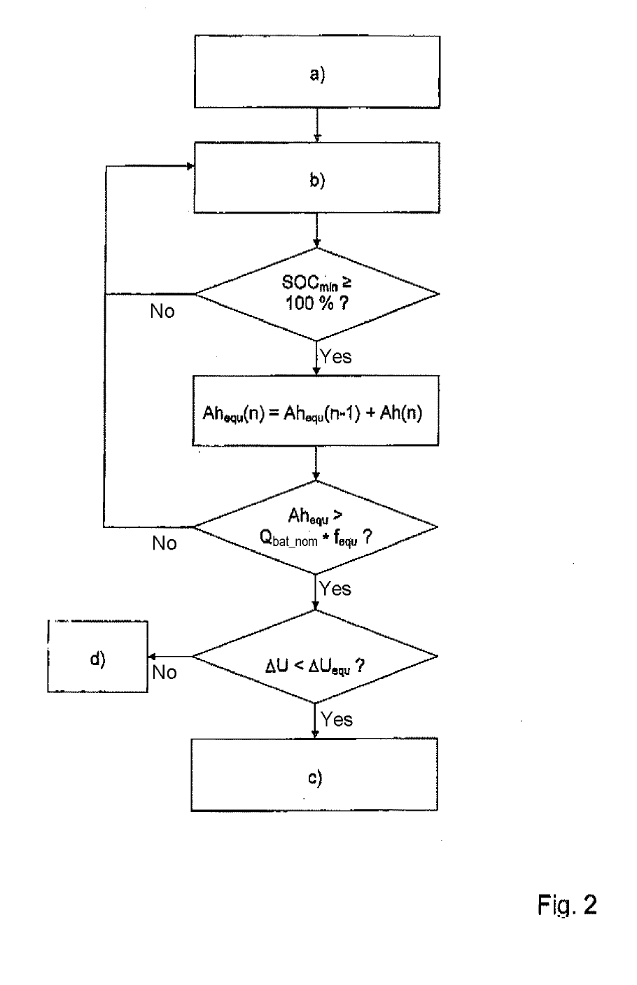

The method carried out by the monitoring device 1 is explained in greater detail with reference to the flowchart illustrated in FIG. 2.

After the need for equalizing charging is detected, an AH counter Ah_{equ} is set to the value 0 Ah in step a) and a vehicle control means is informed that the accumulator 2 requires equalizing charging. The vehicle control means will now attempt to fully charge the accumulator 2 using a moderate current in step b). In this phase, the accumulator 2 may be briefly discharged in the interim and the equalizing charging process may be interrupted by the vehicle being turned off and the journey being continued later.

During equalizing charging, checks are continuously made to determine whether the state of charge SOCₘᵢₙ of the accumulator 2 has reached a defined maximum value (for example 100% of the nominal capacity) since the accumulator 2 enters an overcharging phase at this point. In an overcharging phase, the charge quantities Ah which are charged into the accumulator 2 are added-up in the Ah counter (Ah_{equ}) in which a charge quantity Ah(n) which is charged during the following interval is added to the preceding value of the Ah counter Ah_{equ} (n−1). The Ah counter Ah_{equ} therefore counts only all the charge quantities Ah which are charged into the accumulator 2 in the overcharging phase.

If the overcharging phase is interrupted by discharging operations and, as a result, the state of charge SOCₘᵢₙ drops below the predefined maximum value of 100%, the addition of the charging quantities is stopped until the state of charge is again greater than or equal to the maximum value of 100%. Therefore, the quantity of the determined overcharged charge quantities Ah continues to rise over time.

In order to identify successfully concluded equalizing charging, a check is made as to whether a sufficient charge quantity has been charged and the voltage difference between the highest and lowest module voltage is less than a defined maximum voltage difference. The adequate charge quantity is checked in accordance with the equation

Ah_{equ}>Q_{batt}_{_{—}}ₙₒₘ×f_{equ}

where Qb_{batt}_{_{—}}ₙₒₘ is the nominal capacity of the battery and f_{equ} is a factor which can be freely parameterized and can be fixed, for example, at 15% for NiMH accumulators.

The defined maximum voltage difference ΔU_{equ} is a parameter which is already present in conventional battery monitoring systems for NiMH accumulators and may be, for example, 20 mV/cell.

If successful equalizing charging has been identified, a corresponding message is transmitted in step c), it being possible for said message to initiate a battery control device in order to terminate the equalizing charging process. In addition, a flag which signifies the need for equalizing charging is reset.

If the charge quantity Ah_{equ} is greater than the nominal capacity Q_{batt}_{_{—}}ₙₒₘ, and the voltage difference ΔU was not small enough (ΔU was always greater than Δ and U_{Iqu}), this is an indication that the accumulator 2 cannot be equalized. In this case, a corresponding message is output in step d), in order to initiate examination of the accumulator 2. The accumulator would be in a poor state of health. Cells of the accumulator 2 may be damaged. It is also expedient to continuously monitor the battery temperature. If the maximum temperature is greater than a parameterized value Tₘₐₓ_{_{—}}_{equ} of, for example, 45° C., the accumulator 2 is too hot for equalizing charging. In this case, the monitoring device sets a flag which can initiate a battery control system to stop the equalizing charging and thus signals to the vehicle control system that overcharging should be interrupted until the maximum battery temperature is less than a fixed temperature value Tₛₜₐᵣₜ_{_{—}}_{equ} of, for example, +35° C. In the process, it is possible to specify whether the algorithm for determining equalizing charging is active. Furthermore, it is possible to specify the value of the Ah counter Ah_{equ} and the required discharging quantity Q_{batt}_{_{—}}ₙₒₘ×f_{equ}, the battery temperature Tₘₐₓ_{_{—}}_{cell} which is determined as the maximum during the method, and the voltage difference ΔU.

What is claimed is:

1. A method for determining an equalizing charge of a battery in which the battery is overcharged beyond a nominal full state of charge, the method comprising:
detecting full charging operating phases in which the battery is at least in the nominal full state of charge; and
adding up charge quantities which are charged into the battery in the full charging operating phases to obtain a value of the equalizing charge.

2. The method of claim 1, further comprising comparing the charge quantities which are added up in the full charging operating phases to a defined setpoint equalizing charge and identifying successfully concluded equalizing charging when the added-up charge quantities are greater than the setpoint equalizing charge.

3. The method of claim 1, further comprising determining a voltage difference between a highest and a lowest module voltage, comparing the voltage difference with a defined maximum voltage difference, and identifying successfully concluded equalizing charging when the voltage difference is less than the defined maximum voltage difference.

4. The method of claim 1, further comprising measuring a temperature of the battery and interrupting an equalizing charging process when the measured battery temperature is greater than a defined maximum temperature.

5. The method of claim 4, wherein the maximum battery temperature is in the range of from 40 to 50 degrees Celsius.

6. The method of claim 4, further comprising restarting equalizing charging after the measured temperature has reached a defined lower temperature value.

7. The method of claim 6, wherein the defined lower temperature value is in the range of from 30 to 40 degrees Celsius.

8. The method of claim 1, further comprising determining a state of charge for the battery and interrupting equalizing charging when the state of charge is less than a defined minimum state of charge.

9. The method of claim 8, wherein the defined minimum state of charge before equalizing charging is in the range of from 80 to 100 percent.

10. The method of claim 1, further comprising displaying at least one of a state of the equalizing charge, a charge quantity which is required for initial charging, a voltage difference, or a battery temperature which is measured as a maximum.

11. A monitoring device for batteries comprising:
a device for identifying a current state of charge of a battery;
a charge measuring unit for continuously measuring charge quantities that are charged into the battery;
a monitoring unit configured to detect full charging operating phases in which the battery is at least in a nominal full state of charge and to add up the charge quantities that are charged into the battery in full charging operating phases, the monitoring unit further configured to determine an equalizing charge of the battery as a function of the added-up charge quantities.

12. The monitoring device of claim 11, wherein the monitoring device is further configured to compare the charge quantities which are added up to a defined setpoint equalizing charge and to identify successfully concluded equalizing charging when the added-up charge quantities are greater than the setpoint equalizing charge.

13. The monitoring device of claim 11, wherein the monitoring device is further configured to determine a voltage difference between a highest and a lowest module voltage, and to compare the voltage difference with a defined maximum voltage difference, and to identify successfully concluded equalizing charging when the voltage difference is less than the defined maximum voltage difference.

14. The monitoring device of claim 11, wherein the monitoring device is further configured to measure a temperature of the battery and interrupt an equalizing charging process when the measured battery temperature is greater than a defined maximum temperature.

15. The monitoring device of claim 14, wherein the maximum battery temperature is between 40 and 50 degrees Celsius.

16. The monitoring device of claim 14, wherein the monitoring device is further configured to restart equalizing charging after the measured temperature has reached a defined lower temperature value.

17. The monitoring device of claim 16, wherein the defined lower temperature value is between 30 and 40 degrees Celsius.

18. The monitoring device of claim 1, wherein the monitoring device is further configured to determine a state of charge for the battery and interrupt equalizing charging when the state of charge is less than a defined minimum state of charge.

19. The monitoring device of claim 18, wherein the defined minimum state of charge before equalizing charging is between 80 and 100 percent.

20. The monitoring device of claim 1, wherein the monitoring device is further configured to display at least one of a state of the equalizing charge, a charge quantity which is required for initial charging, a voltage difference, or a battery temperature which is measured as a maximum.
